(19) United States
(12) Patent Application Publication
(10) Pub. No.: US 2012/0216902 A1
(43) Pub. Date: Aug. 30, 2012

(54) METHOD OF MANUFACTURING A FLUOROPOLYMER TUBE WITH LINING

(75) Inventors: David Yanik, Marion, NC (US); Bruce Graning, Marion, NC (US); Landon Grindstaff, Marion, NC (US)

(73) Assignee: CRANE CHEMPHARMA RESISTOFLEX, Marion, NC (US)

(21) Appl. No.: 13/221,338

(22) Filed: Aug. 30, 2011

Related U.S. Application Data
(63) Continuation of application No. PCT/US10/25855, filed on Mar. 2, 2010.
(60) Provisional application No. 61/156,781, filed on Mar. 2, 2009.

(51) Int. Cl. F16L 11/00; B32B 37/16

(52) U.S. Cl. 138/121; 156/294

(57) ABSTRACT

A hose assembly and a method of manufacturing a hose assembly are provided. The method includes providing an inner corrugated lining composed of a polymeric material, providing an outer hose assembly having a length that exceeds the target length and configured to receive the inner corrugated lining therethrough, concurrently drawing the inner lining through a reducing die and the outer hose assembly, and expanding the inner lining within the outer hose assembly to form an interference fit at least at ends of the inner lining and outer carcass. The outer hose assembly length is sufficient to compress to the target length upon the expansion of the inner lining.

### BACKGROUND OF THE INVENTION

1. Field of the Invention

This invention relates generally to hoses and tubular conduits, and more particularly to hoses which have an inner lining made of a polymeric material, particularly of a fluoropolymer, and more particularly PTFE, that is drawn into an outer reinforcement carcass. The carcass is any elastomeric rubber material with or without fabric and/or spiral wire reinforcements.

2. Related Art

Conduits and hoses are essential components of many apparatuses in a wide variety of fields, for example, in biotechnical applications, pharmaceuticals, medicine, etc. In devices used in such fields, it is often important to transport liquids or other fluids in a sanitary manner, without contamination.

One type of tubing that is designed for this purpose is made from polytetrafluoroethylene (PTFE), commonly sold commercially under the trade name Teflon® (E.I. Dupont).

PTFE offers very good heat resistance, is chemically inert and corrosion resistant, and has excellent dielectric strength. However, PTFE tubing has some disadvantages. Hose manufacturers typically bond the PTFE lining to the carcass so that the lining behaves as if it were part of the carcass. Without bonding of the lining to the carcass, the minimum bend radius of the lining is larger than desirable. The reason for this larger bend radius of the lining is the tendency for the lining (without bonding) to “buckle” at the inner bend radius due to compressive stresses creating a “kink” and inward separation of the lining from the carcass. This “kink” effect can be partially mitigated by increasing the thickness of the lining, but the force required to bend the product, and the weight and cost of the hose assembly, are increased.

Corrugated PTFE tubing has been used to reduce the bend radius. However, corrugated PTFE tubing has its own disadvantages, particularly, in having increased pressure drop through the hose due to the increased flow resistance from the internal corrugations. Moreover, the internal corrugations protrude into the tubing and thus form spaces where fluid can collect upon drainage of the tubing, making cleaning of the tubing more difficult. Furthermore, any external corrugated surfaces of the tubing are also subject to abrasion, contact, and fatigue due to bending and possible vibration.

Corrugated PTFE tubing also may be manufactured with a carcass that covers the corrugations. Such coverings may provide further benefits such as insulation, abrasion resistance to protect the corrugations, and increased pressure rating of the hose assembly by reinforcing the inner lining. Conventionally the PTFE tubing and/or carcass is either etched or otherwise chemically treated or activated before the two are bonded together, usually by a vulcanizing process. The resulting lined PTFE tubing generally is stiffer than its unlined counterpart, partially reducing some of the benefits of using corrugated PTFE tubing.

The foregoing methods of bonding can be quite costly, difficult to perform, and time consuming. Besides adding an extra step to the process, commonly used etchants can be dangerous or at least inconvenient to work with. Etchants may come into contact with a process fluid if the lining is breached. The risk of an etchant mixing with the process fluid is especially relevant in the biopharmaceutical industry, where strict cleanliness and purity standards are imposed.

There exists, therefore, a need for a hose and corresponding methods of making the same which overcome these and other drawbacks associated with prior art hoses and methods. In particular, there is a need for a hose and a method of manufacturing to produce a lined smooth-bore hose produced without chemical treatment of any kind, but yet provide the flexibility of a corrugated PTFE tube.

### SUMMARY OF THE INVENTION

Accordingly, it is an object of the present invention to overcome conventional problems associated with prior art hoses and methods of making the same by providing a hose and method of manufacturing the same which is flexible, does not require the use of etchant or chemical treatment to manufacture, has a smooth bore, has a minimum bend radius and force to bend, has high vacuum resistance, and retains all of the advantages of PTFE as a wetted fluid transfer surface.

In a first aspect of the invention a method of manufacturing a hose assembly having a target length is provided. The method includes providing an inner corrugated lining composed of a polymeric material and providing an outer carcass assembly having a length that exceeds the target length by as much as ten percent and configured to receive the inner corrugated lining therethrough.

The method also includes pulling a lining through a reducing die and concurrently through the carcass assembly to be lined. The pulling operation is halted and the tensile load in the lining is released after the lining is completely through the carcass and exits through the reducing die at the other end. The result is that the inner lining expands to form an interference fit between the inner lining and the outer carcass. The outer carcass length is sufficient to compress to the target length upon the expansion of the inner lining.

By virtue of the method provided, a finished hose assembly having an unbonded and untreated inner lining, in friction contact with an outer carcass, is formed under axial tension to reduce the compressive buckling stress when the hose assembly is bent. The resulting axial tension in the inner lining is balanced by an equal and opposite axial compression force in the outer carcass. While one embodiment of the method includes drawing the inner lining through a reducing die and into the outer carcass, one of skill in the art will appreciate that other processes for achieving the opposing axial forces between the inner lining and the outer carcass are within the scope of the invention. In one embodiment the polymeric material is PTFE. Moreover, the drawing step further includes resiliently deforming corrugations of the inner corrugated lining to make them substantially smooth, while retaining sufficient memory to avoid a three lobe vacuum collapse when the inner lining is exposed to a certain operating temperature.

These and other aspects of the invention will be more clearly understood by reference to the following detailed description of exemplary embodiments in conjunction with the accompanying drawings.

### BRIEF DESCRIPTION OF THE DRAWINGS

FIG. 1 shows an embodiment of a method of manufacturing a hose assembly in accordance with one aspect of the invention.

FIG. 2 shows a hose assembly at one stage in the manufacturing of the hose assembly.

FIG. 3 shows a manufactured hose assembly in accordance with another aspect of the invention.

### DETAILED DESCRIPTION OF THE PREFERRED EMBODIMENTS

The invention will next be described in connection with certain exemplary embodiments; however, it should be clear to those skilled in the art that various modifications, additions, and subtractions can be made without departing from the spirit or scope of the claims.

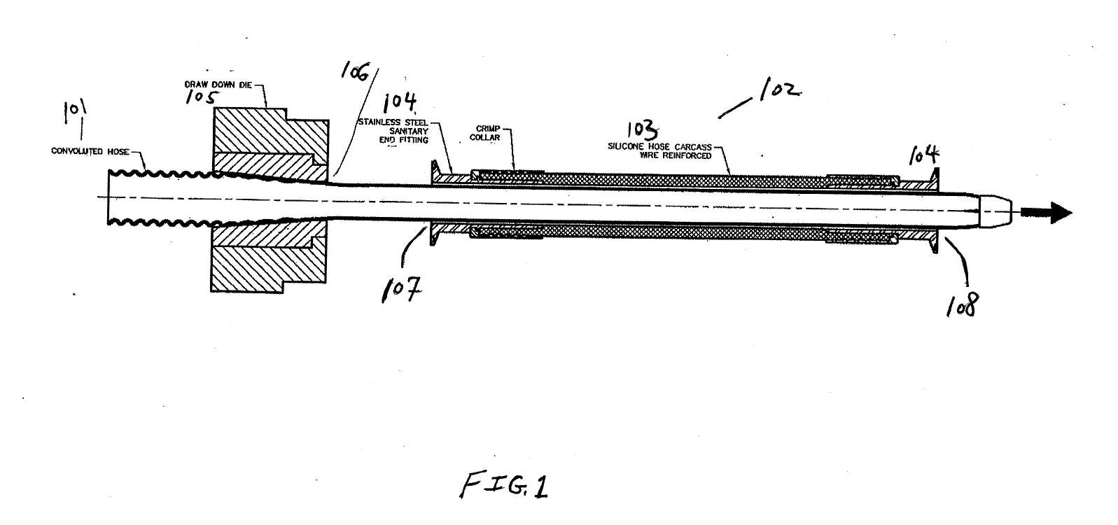

FIG. 1 shows an embodiment of a method of manufacturing a lined hose assembly. In a preferred embodiment of the present invention, a hose lining 101 made of polymer material, specifically polytetrafluoroethylene (PTFE). One reason PTFE is preferred to other fluoropolymers is that it has a superior flex life. PTFE also possesses exceptional resistance to chemical degradation and vapor permeation, and is usable over a broad temperature range. Of course, linings usable in the present invention (as most broadly conceived) are not necessarily limited to PTFE, and other polymer or elastomeric materials may be used as well.

In the method of manufacturing the lined hose assembly, an inner corrugated PTFE lining 101 and an outer hose assembly 102 are provided. The outer hose assembly 102 includes a carcass 103 and fittings 104, which are attached to the ends of the carcass 103, for example, by crimping the fitting 104 onto the carcass 103. The outer hose assembly 102 can be lined according to the methods described herein. The length of the outer carcass 103 is constructed to be longer than a finished target length of the lined hose assembly to allow for axial shrinkage of the lining 101 and the carcass 103, as will be described below. The fittings 104 are used to connect the finished hose assembly to other fittings 104. For example, in the embodiment shown in FIG. 1, the fittings 104 are sanitary end fittings. Neither the inner lining 101 nor the outer carcass 103 is etched or otherwise chemically treated.

In one embodiment, the lining 101 has an annular cross-section. The inner diameter of the lining may be between ½ and 2 inches, having a wall thickness between 0.035 and 0.060 inches; however, other dimensions of the inner diameter and wall thickness are possible, as will be appreciated by those of skill in the art. The height of the convolutions is preferably dimensioned to be about 10% to 30% of the inner diameter of the lining, but, again, other dimensions are possible. The inner diameter of the undeformed convoluted hose lining is larger than the inner diameter of the outer hose assembly 102. Moreover, an exit 106 of the reducing die 105 has a diameter that is less than the inner diameter of the outer hose assembly 102.

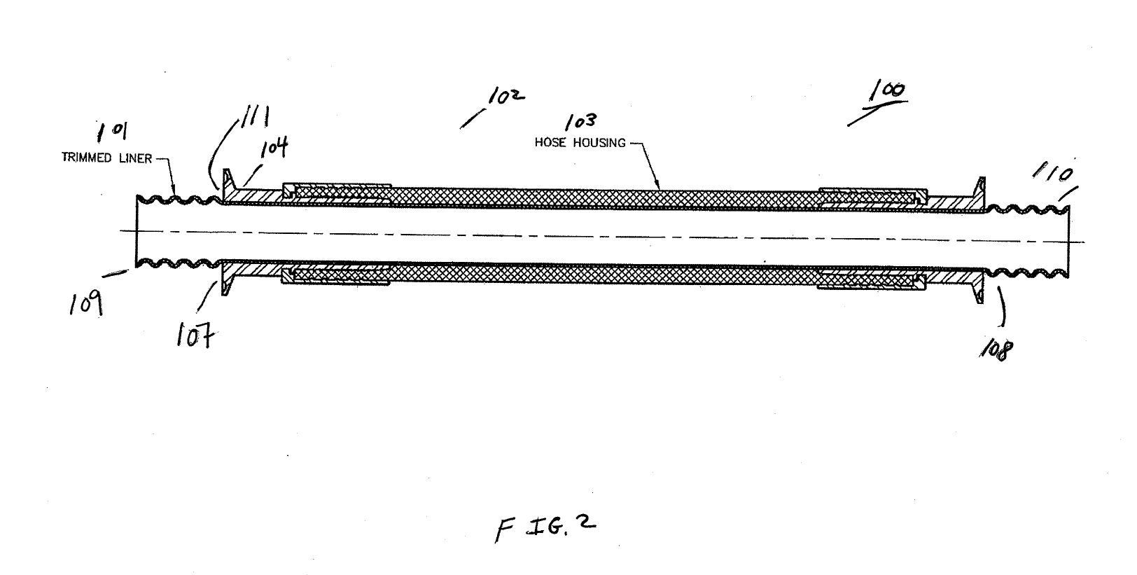

The inner PTFE lining 101 is drawn in the direction of the arrow shown in FIG. 1 through a reducing die 105 and concurrently through the outer hose assembly 102 at room temperature. The lining 101 enters a first end 107 of the outer hose assembly 102 and is drawn through to a second, opposite end 108, of the outer hose assembly 102. A constant tensile load is applied to the lining 101 as it is drawn through the die 105 and the outer hose assembly 102. The tensile load is the result of resistance from drawing the lining 101 through the reducing die 105. The diameter of the exit 106 of the reducing die 105 is smaller than the inner diameter of the outer hose assembly 102 to discharge the lining 101 with an outer diameter that is less than the inner diameter of the outer hose assembly 102 and such that clearance is provided between the lining 101 and the outer hose assembly 102 as the lining 101 is drawn into and through the outer assembly 102 at room temperature. The lining 101 is drawn through the reducing die 105 and the outer hose assembly 102 at least until the lining 101 clears the second end 108 of the outer hose assembly 102. As shown in FIG. 2, the lining 101 is drawn beyond the second end 108 of the outer hose assembly 102 a certain amount.

The inner lining 101 may be cold drawn, or alternatively hot drawn, into the outer hose assembly 102 to achieve the desired result. When the lining 101 is drawn through the die 105 and into the outer hose assembly 101, the process eliminates or substantially reduces the corrugations making the inner bore of the inner lining 101 relatively smooth compared to the undeformed corrugated inner lining 101. In one example, the height of the convolutions is reduced by 95% to 98%. Moreover, as will be discussed in further detail below, after the drawing operation the lining 101 retains a memory of the corrugations such that the overall finished hose assembly 100 is flexible. The drawing process imparts a controlled distribution of forces to the lining to reduce kinking when flexed, when compared to purely smooth bore tubing. Moreover, the force necessary to bend the drawn hose liner 101 is substantially reduced when compared to smooth bore tubing of the same nominal dimensions. Accordingly, in the case of an embodiment of a hose assembly 100 constructed using a liner 101 formed from PTFE, such a hose assembly, processed in accordance with the method described herein, retains all of the desirable attributes of PTFE while providing the desired flexibility and smooth inner bore found in conventional silicone hoses.

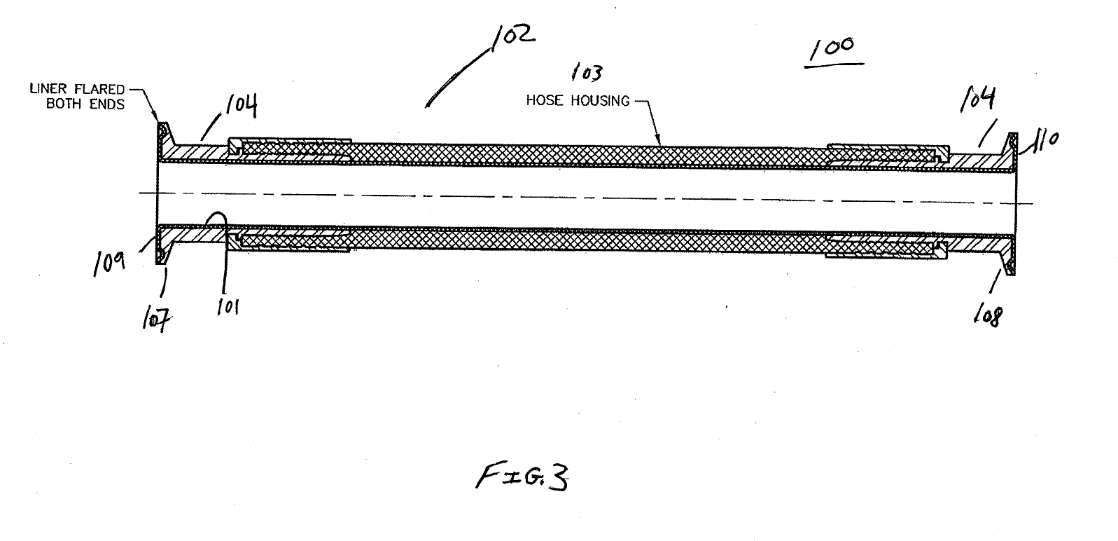

The drawing operation is halted whenever a last remaining portion of the lining 101 exits the die 105 or the lining is severed between the first end 107 of the outer hose assembly 102 and the die 105. Preferably, drawing is halted so that a first end 109 of the lining 101 extends from the first end 107 of the outer hose assembly 102 and a second end 111 of the lining 101 extends from the second end 108 of the outer hose assembly 102. When the drawing operation is halted and the applied tensile drawing force is removed, an immediate radial expansion and axial contraction of lining 101 occurs while the lining 101 is positioned within the outer hose assembly 102. The inner diameter of the hose carcass 103 and the end fittings 104 constrain the radial expansion of the lining 101. By virtue of the radial expansion of the lining 101, the outer surface of the lining 101 comes into contact with the inner surfaces of the carcass 103 and the fittings 104. The outward pressure exerted by the radially expanding lining 101 against the inner surfaces of the carcass 103 and the fittings 104 provides a friction fit between those surfaces sufficient to limit relative axial movement between the lining 101 and the outer hose assembly 102. As the lining 101 expands radially toward the inner surface of the outer hose assembly 102, the lining 101 tends to contract axially due to memory in the lining 101 imparted by the convolutions in the lining that exist prior to drawing the lining 101 through the die 105. The applied friction force between the lining 101 and the inner surface of the outer hose assembly 102 counteracts the force exerted by the lining tending to axially contract the lining 101. However, the axial contraction is partially limited, and the lining 101 prevented from returning to its original contracted convoluted shape, due to the friction force applied as a result of the radial expansion of the lining 101. The contracting force of the lining 101 is taken up by the outer hose assembly, which contracts the outer hose assembly. The counteracting friction force on the lining 101 imparts a residual axial tensile load on the lining 101 after the lining expands and during further processing of the hose assembly. Such a residual tensile force on the hose lining 101 retains a substantially smooth inner surface, which imparts the desired properties of the finished hose assembly 100 (FIG. 3).

In the absence of the tensile force applied during the drawing operation, the first and second ends 109 and 110 of the lining 101 are free to contract due to the memory of the convolutions. To finish the ends of the hose assembly 100, ends 109 and 110 of the lining 101 are locally heated and flared onto the fittings 104, which are shown in FIGS. 1-3 as sanitary fittings having an annular groove formed in a flanged sealing surface 111 (FIG. 2). A flaring tool is used to apply pressure over the flared lining to impress a net-formed shape onto the sealing surface 111 of the fitting 104. The flaring tool is applied such that the net-formed shape of the lined flange conforms to the surface 111 and groove of the sanitary flange fitting 104.

By flaring the lining onto the surface 111 of the fitting 104, an interference fit is created between the lining 101 and the fittings 104. As a result of this interference fit, the residual tensile load on the inner lining 101 can be partially transferred between the fittings 104 and any residual creep in the lining 101 tending to axially contract the lining can be avoided. Heating and flaring of the inner lining 101 is accomplished as soon after the drawing operation is halted, and preferably within the same day that the lining 101 is inserted into the outer hose assembly 102 to maintain the residual axial tensile load of the inner lining 101.

The methods described in accordance with the present invention do not require etching or chemically treating the surfaces of the inner lining 101 or outer hose assembly 102, thereby avoiding all of the complexities which arise from such processing steps. It should be understood, however, that if for any reason such etching or chemical treatment is performed, that does not depart from the scope of the present invention, provided that the terms of the appended claims are met.

An unbonded hose assembly 100 produced in accordance with the invention has drainability similar to smooth bore hoses and yet has the flexibility, low force to bend, and vacuum resistance of convoluted hoses. All of this is achieved without the risk of chemical activators to promote adhesion of any kind.

The invention has been described in connection with certain exemplary embodiments. However, it should be clear to those skilled in the art that various modifications, additions, subtractions, and changes in form and details may be made to those embodiments without departing from the spirit or scope of the invention as set forth in the claims below.

What is claimed is:

1. A method of manufacturing a hose having a target length, comprising:
providing an inner corrugated lining composed of a polymeric material;
providing an outer carcass assembly having a length that exceeds the target length and configured to receive the inner corrugated lining therethrough;
concurrently drawing the inner lining through a reducing die and the outer carcass; and
expanding the inner lining within the outer carcass to form an interference fit at least at ends of the inner lining and outer carcass, wherein the outer carcass length is sufficient to compress to the target length upon the expansion of the inner lining.

2. The method as set forth in claim 1, wherein the polymeric material is PTFE.

3. The method as set forth in claim 1, in which said step of drawing the inner corrugated lining is performed with the outer surface of the inner corrugated lining and the inner surface of the outer carcass assembly not etched and not chemically treated.

4. The method as set forth in claim 1, in which said step of drawing the inner corrugated lining is performed by cold drawing.

5. The method as set forth in claim 1, in which said step of drawing the inner corrugated lining is performed by hot drawing.

6. The method as set forth in claim 1, wherein said step of drawing the inner corrugated lining further includes resiliently deforming corrugations of the inner corrugated lining to make them substantially smooth while retaining a memory of the corrugations.

7. The method as set forth in claim 1, further comprising halting said step of drawing the inner corrugated lining when a last remaining portion of the inner lining exits the reducing die and an immediate expansion of the lining within the carcass occurs to provide an interference fit.

8. The method as set forth in claim 7, further comprising introducing a fitting at each end of the hose assembly between the inner lining and the carcass.

9. The method as set forth in claim 8, further comprising locally heating the inner lining at each end of the hose assembly and flaring the inner lining over and onto wetted surfaces of the fitting.

10. A hose assembly, comprising:
an inner corrugated lining composed of a polymer; and
an outer carcass assembly surrounding the inner corrugated lining, the outer carcass having an inner surface configured to receive the inner corrugated lining by drawing the inner corrugated lining therethrough.

11. The hose according to claim 10, wherein the inner corrugated lining is composed of PTFE.

12. The hose according to claim 10, wherein an outer surface of the inner corrugated lining and an inner surface of the outer carcass are not etched and are not chemically treated.

13. The hose according to claim 12, wherein corrugations of the inner corrugated lining are resiliently deformed substantially smooth upon being drawn through the outer carcass such that the lining retains a memory of the corrugations.

14. The hose according to claim 13, wherein friction between the inner lining and the inner surface of the outer carcass at ends thereof provides residual axial tensile load on the lining and corresponding compressive load on the hose carcass.

15. The hose according to claim 14, including fittings at ends of the hose assembly introduced between the inner lining and the outer carcass, wherein ends of the inner lining are flared over wetted surfaces of the fittings.

16. A hose assembly manufactured by the method of claim 1.
